(19) United States
(12) Patent Application Publication
(10) Pub. No.: US 2023/0405608 A1
(43) Pub. Date: Dec. 21, 2023

(54) A PROTECTING COLLAR AND A CENTRIFUGAL SEPARATOR

(71) Applicant: ALFA LAVAL CORPORATE AB, LUND (SE)

(72) Inventors: Markus BÖRJES, ÄLVSJÖ (SE); Ken ROOS, VENDELSÖ (SE); John BENTSEN, HÄGERSTEN (SE); Hampus BRANÄNG, HÄGERSTEN (SE); Michael NORBÄCK, RÖNNINGE (SE)

(73) Assignee: ALFA LAVAL CORPORATE AB, LUND (SE)

(21) Appl. No.: 18/037,254

(22) PCT Filed: Nov. 22, 2021
(86) PCT No.: PCT/EP2021/082457

§ 371 Date: May 16, 2023

(30) Foreign Application Priority Data
Dec. 14, 2020 (EP) 20213756.8

(51) Int. Cl. B04B 9/08; B04B 9/12

(52) U.S. Cl. CPC B04B 9/08; B04B 9/12; B04B 1/08

(57) ABSTRACT

A protecting collar for a centrifugal separator is arranged to rotate with a rotatable part of the centrifugal separator and includes a cavity provided with an inner wall including a first inner peripheral surface portion and an inner abutment surface; a first and a second opening of the cavity, which first opening has a larger diameter than the second opening; an outer wall including an outer peripheral surface and an outer abutment surface. The protecting collar includes a lubricant barrier generating element arranged in the first inner peripheral surface portion, which lubricant barrier generating element is configured to prevent the lubricant to pass the lubricant barrier generating element during a rotational movement of the protecting collar. The lubricant barrier generating element is a helical groove formed in the first inner peripheral surface portion. A centrifugal separator includes the protecting collar.

### TECHNICAL FIELD

The present disclosure relates to a protecting collar and a centrifugal separator.

### BACKGROUND ART

Centrifugal separators are generally used for separation of liquids and/or solids from a liquid mixture or a gas mixture. During operation, fluid mixture that is about to be separated is introduced into a rotating bowl and due to the centrifugal forces, heavy particles or denser liquid, such as water, accumulates at the periphery of the rotating bowl whereas less dense liquid accumulates closer to the centre axis of rotation. This allows for collection of the separated fractions, e.g. by means of different outlets arranged at the periphery and close to the rotational axis, respectively. Separation discs are stacked in the rotating bowl at a mutual distance to form interspaces between themselves, thus forming surface-enlarging inserts within the bowl.

One application in which centrifugal separators are used is in the biotech industry, such as in clean-rooms at pharmaceutical sites. During operation, substances moves outwards in the interspaces between discs in the stack of separation discs used in the centrifugal separator, whereas one phase of the substance, having a lower density than another phase of the substance moves radially inwards towards the axis of rotation. Both phases may thus be collected via the different outlets.

Due to demands on machines situated in clean-rooms at pharmaceutical sites, any components and additives such as lubricants in the centrifugal separator should not affect the environment in the clean-room.

Document WO201877921 shows an example of a centrifugal separator used for separation of at least two components of a fluid mixture which are of different densities. The centrifugal separator comprises a rotor, which is rotatably supported by a frame around a rotational drive shaft; an inlet to the rotor; a first outlet for a separated lighter first component of the fluid mixture, a second outlet for a separated denser second component of the fluid mixture and third outlet for discharge of sludge.

### SUMMARY OF THE INVENTION

There are known centrifugal separators, which suffer from oil leakage. This is not acceptable due to environment demands. The leakage of oil may be limited, but for example in clean rooms at pharmaceutical sites, even a small oil leakage may not be acceptable. The oil leakage of the known centrifugal separators may emanate from locations where relative rotational movement between surfaces occurs. There are also known centrifugal separators provided with rotatable surfaces, which directs lubricant in unexpected directions, resulting in oil leakage.

There is thus a need for an improved centrifugal separator, which is tight from leakage of lubricants. There is also a need to develop an improved centrifugal separator, which compensates for any lubricant flow generated by rotatable surfaces of the separator.

An objective of the invention is thus to provide an improved centrifugal separator, which is tight from leakage of lubricants. A further objective is to develop an improved centrifugal separator, which compensates for any lubricant flow generated by rotatable surfaces of the separator.

These objectives are achieved by a protecting collar and a centrifugal separator according to the appended claims.

According to an aspect of the invention, a protecting collar for a centrifugal separator is provided. The protecting collar comprising: a cavity provided with an inner wall comprising a first inner peripheral surface portion and an inner abutment surface; a first and a second opening of the cavity, which first opening has a larger diameter than the second opening; an outer wall comprising an outer peripheral surface and an outer abutment surface; wherein, the protecting collar further comprising: a lubricant barrier generating element arranged in the first inner peripheral surface portion, which lubricant barrier generating element is configured to prevent the lubricant to pass the lubricant barrier generating element during a rotational movement of the protecting collar. The protecting collar is arranged to rotate with a rotatable part of the centrifugal separator. The rotatable part may for example be a rotatable shaft, such as a rotatable shaft used for supporting the centrifuge bowl of the centrifugal separator. Such a shaft may also be used for supply of liquid mixture to be separated to the centrifugal separator.

Further, the lubricant barrier generating element may be a helical groove formed in the first inner peripheral surface portion. Thus, the lubricant barrier generating element may be integrated in the first inner peripheral surface portion. Further, the lubricant barrier generating element may be arranged to prevent the lubricant to pass the lubricant barrier generating element only during a rotational movement of the protecting collar, and thus not during standstill of the protecting collar.

Such protecting collar prevents leakage of lubricants from a centrifugal separator. Due to the lubricant barrier generating element arranged in the first inner peripheral surface portion the lubricant may not pass the lubricant barrier generating element during a rotational movement of the protecting collar. This has the advantage that the lubricant is prevented from reaching a location of leakage at the centrifugal separator.

Moreover, the collar may not form part of a double mechanical seal, in which a rotatable ring seals against a stationary ring. Thus, the protecting collar may be free of any means for cooling the protecting collar.

According to a further aspect of the invention, a centrifugal separator for separating a fluid mixture into components is provided. The centrifugal separator is comprising: a rotor, which is rotatably supported by a frame around a rotational drive shaft; an inlet to the rotor; a first outlet for a separated lighter first component of the fluid mixture; and a second outlet for a separated denser second component of the fluid mixture; wherein the centrifugal separator further comprises a protecting collar disclosed herein arranged on the rotatable drive shaft.

Such centrifugal separator is tight from leakage of lubricants. The protecting collar will prevent leakage of lubricants from the centrifugal separator. Further, the centrifugal separator, due to the protecting collar, will compensate for any lubricant flow generated by rotatable surfaces of the separator. This has the advantage that there will be no leakage of lubricant from the centrifugal separator, and thus, such centrifugal separator may be used in clean-rooms at pharmaceutical sites.

Further objects, advantages and novel features of the present invention will become apparent to one skilled in the art from the following details, and also by putting the invention into practice. Whereas examples of the invention are described below, it should be noted that it is not restricted to the specific details described. Specialists having access to the teachings herein will recognise further applications, modifications and incorporations within other fields, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various figures, and in which:

FIG. 1 illustrates a schematic side view of a centrifugal separator according to an example;

FIG. 2a illustrates a section view of a protecting collar according to an example;

FIG. 2b illustrates a view in perspective of a protecting collar according to an example;

FIG. 3 illustrates a section view of a protecting collar arranged in a bearing housing of a centrifugal separator according to an example; and

FIG. 4 illustrates a detail section view of a protecting collar arranged in a bearing housing of a centrifugal separator according to an example.

### DETAILED DESCRIPTION

The detailed description with reference to the examples depicted are to be viewed as examples comprising a combination of certain features, which features have been described in detail above. It is thus to be understood that additional examples may be achieved by combining other features into examples not depicted herein. The figures are to be viewed as examples and not mutually exclusive combinations. It should also be noted that all figures shown and described are schematically represented, wherein generic parts of machinery or similar is not depicted for the sake of simplicity.

According to an aspect of the present disclosure, a protecting collar for a centrifugal separator is provided. The protecting collar is arranged to rotate with a rotatable part of the centrifugal separator. The protecting collar comprising: a cavity provided with an inner wall comprising a first inner peripheral surface portion and an inner abutment surface; a first and a second opening of the cavity, which first opening has a larger diameter than the second opening; an outer wall comprising an outer peripheral surface and an outer abutment surface; wherein, the protecting collar further comprising: a lubricant barrier generating element arranged in the first inner peripheral surface portion, which lubricant barrier generating element is configured to prevent the lubricant to pass the lubricant barrier generating element during a rotational movement of the protecting collar.

Centrifugal separators may be used for separation of liquids and/or solids from a liquid mixture or a gas mixture. Centrifugal separators may comprise a lubricant for lubricating gears and bearings in the centrifugal separators.

The protecting collar may prevent leakage of lubricant from a centrifugal separator. Leakage of lubricant from a centrifugal separator may have a negative impact on the environment surrounding the centrifugal separator. Further, the leakage may over time drain the centrifugal separator of lubricant, which may lead to unwanted wear of the components in the centrifugal separator. The protecting collar may have rotationally symmetrical shape. The protecting collar may be connected to a rotational component in the centrifugal separator.

The protecting collar may be provided with a cavity defined by an inner wall of the protecting collar. The inner wall may have a certain extension in an axial direction of the protecting collar. The inner wall may be divided in different portions, such as a first inner peripheral surface portion. Thus, the first inner peripheral surface portion encircles the cavity. The first inner peripheral surface portion may have a certain axial extension within the cavity. Further, the inner wall may also comprise an inner abutment surface. The inner abutment surface may be configured for axial fixation of the protecting collar. The inner abutment surface may be a flat surface having a normal which coincides or is parallel with a rotationally symmetrical axis of the protecting collar.

The first opening may be a circular opening. The first opening may have a centre axis, which coincides with the rotationally symmetrical axis of the protecting collar. The second opening may be a circular opening. The second opening may have a centre axis, which coincides with the rotationally symmetrical axis of the protecting collar. The first opening may be a bore, which extends in an axial direction from the cavity to the outer surface of the protecting collar. The bore has a circular bore wall with an axial extension. The centre axles of the first and second openings may coincide. The diameter of the first opening is larger than the diameter of the second opening.

The protecting collar comprises an outer wall, which has an axial extension. The outer wall may be circular. The outer wall comprises an outer peripheral surface, which encircles the protecting collar. The outer peripheral surface may have a certain axial extension. The outer wall may have an outer abutment surface. The outer abutment surface may be configured for axial fixation of the protecting collar. The outer abutment surface may be a flat surface having a normal which coincides or is parallel with a rotationally symmetrical axis of the protecting collar. The outer abutment surface may encircle the second opening.

The lubricant barrier generating element may be any type of element, which prevents the lubricant to pass the element. The shape of the lubricant barrier generating element may prevent the lubricant to pass the element. The lubricant barrier generating element may be any type of element, which generates a lubricant flow out of the cavity. The shape of the lubricant barrier generating element may generate a lubricant flow out of the cavity. The cavity may partly be filled with lubricant. The lubricant barrier generating element may be configured to hold a certain volume of lubricant. During a rotational movement of the protecting collar, the lubricant barrier generating element may be configured to prevent the lubricant to pass the element. During a rotational movement of the protecting collar, the lubricant barrier generating element may be configured to generate a lubricant flow out of the cavity. Thus, the lubricant barrier generating element may be configured to prevent the lubricant to pass the lubricant barrier generating element in one direction and to allow the lubricant to pass the lubricant barrier generating element in the opposite direction, i.e. out of the cavity. The lubricant barrier generating element may be configured to prevent the lubricant to pass the lubricant barrier generating element in a direction from de first opening to the second opening of the protecting collar and to allow the lubricant to pass the lubricant barrier generating element in direction from the second opening to the first opening.

The lubricant may be any type of lubricant that may decrease friction between moving parts or between a moving part and a stand still part. The lubricant may have a high or low viscosity. The lubricant may protect components from corrosion.

According to an aspect, the lubricant barrier generating element is a helical groove formed in the first inner peripheral surface portion. During a rotational movement of the protecting collar, the helical groove may prevent the lubricant to pass the element. The lubricant will be forced by the rotational movement of the helical groove to enter the helical groove. The helical groove may be configured similar as the shape of a thread in a nut or on a screw. During a rotational movement of the protecting collar, the helical groove may generate a lubricant flow out of the cavity. Any lubricant, which may enter the helical groove, may be flushed out of the helical groove by the generated lubricant flow.

According to an aspect, a groove opening of the helical groove is configured to trail in the lubricant during the rotational movement of the collar, so that the lubricant is prevented to enter the helical groove. The groove opening of the helical groove may be configured in the first inner peripheral surface portion at the first opening of the cavity. The groove opening may have direction towards the first opening of the cavity. During the rotational movement of the protecting collar, the helical groove may trail in the lubricant, which surrounding the first opening of the cavity.

According to an aspect, the inner wall of the cavity comprises a second inner peripheral surface portion adjacent to the first inner peripheral surface portion, which second inner peripheral surface portion has a tapered shape. The tapered shape of the second inner peripheral surface portion may be adapted to surrounding components of the centrifugal separator. The separator my for example comprise a bearing housing, which is configured to at least partly surround the protecting collar. The bearing housing may comprise a tapered portion, which is configured to protrude into the cavity of the protecting collar. This configuration may result in a circumferential conical shaped gap or column between the second inner peripheral surface portion and the tapered portion of the bearing housing. The circumferential conical shaped gap or column may have a shape similar to a truncated cone. The second inner peripheral surface portion may be provided with a further lubricant barrier generating element, which may be similar to or different from the lubricant barrier generating element arranged in the second inner peripheral surface portion of the inner wall of the cavity.

According to an aspect, the shape of the outer peripheral surface of the outer wall is configured to guide a flow of lubricant past the collar. The outer peripheral surface may be smooth without any irregularities in order to facilitate the lubricant to flow on the outer peripheral surface. The direction of flow of the lubricant may be in a parallel direction in relation to the centre axis of the collar. The flow of the lubricant on the outside of the collar may have a cylindrical shape.

According to an aspect, the cavity is configured to receive a throttle ring, which has an outer diameter smaller than the inner diameter of the first inner peripheral surface portion, which throttle ring is configured to stand still during the rotational movement of the protecting collar. Since the outer diameter of the throttle ring is smaller than the inner diameter of the first inner peripheral surface portion, the collar is free to rotate in relation to the throttle ring. Due to the difference in diameter between the outer diameter of the throttle ring is smaller than the inner diameter of the first inner peripheral surface portion a cylinder-shaped gap is formed between the throttle ring and the collar. The lubricant is prevented to enter the cylinder-shaped gap by the lubricant barrier generating element of the collar. An end surface of the throttle ring may be configured to abut the inner abutment surface of the inner wall of the protecting collar. The throttle ring may be allowed to move on an axial direction in relation to the collar.

According to an aspect, the cavity is configured to receive a rotatable drive shaft passing through the first and second opening. The rotatable drive shaft may be configured to generate a rotatable movement of the protecting collar. The rotatable drive shaft may be configured to generate a rotatable movement about the centre axis of the protecting collar. The throttle ring may comprise a central through hole. The rotatable drive shaft may be arranged to pass through the central through hole of the throttle ring. The central through hole of the throttle ring has a larger diameter than an outer diameter of the rotatable drive shaft.

According to a further aspect of the present disclosure, a centrifugal separator for separating a fluid mixture into components is provided. The centrifugal separator is comprising: a rotor, which is rotatably supported by a frame around a rotational drive shaft; an inlet to the rotor; a first outlet for a separated lighter first component of the fluid mixture; and a second outlet for a separated denser second component of the fluid mixture; wherein the centrifugal separator further comprises a protecting collar disclosed herein arranged on the rotatable drive shaft.

Centrifugal separators may be used for separation of liquids and/or solids from fluid mixture, such as a liquid mixture or a gas mixture. During operation, fluid mixture that is about to be separated into components, is introduced into a rotating bowl of the rotor and due to the centrifugal forces, a heavy component accumulates at the periphery of the rotating bowl whereas less dense component accumulates closer to the centre axis of rotation. This allows for collection of the separated components, e.g. by means of different outlets arranged at the periphery and close to the rotational axis, respectively. Separation discs are stacked in the rotating bowl at a mutual distance to form interspaces between themselves, thus forming surface-enlarging inserts within the bowl. Centrifugal separators are used is in the biotech industry, such as in clean-rooms at pharmaceutical sites. During operation, substances moves outwards in the interspaces between discs in the stack of separation discs used in the centrifugal separator, whereas one component of the substance, having a lower density than another component of the substance moves radially inwards towards the axis of rotation. Both components may thus be collected via the different outlets. The first outlet may be arranged close to the axis of rotation. The second outlet may be arranged at the periphery of the rotating bowl. The separator may also comprise at third outlet arranged close to the axis of rotation. The number of outlets depends on the number of components to be separated from the fluid mixture. The fluid mixture may comprise any kind substances or components such as substances or components used in the biotech industry or any other industry. The fluid mixture may comprise a number of different components.

The rotor comprises the rotating bowl in which the fluid mixture is introduced. The rotor is rotatably supported by a frame. The frame may be configured to enclose the rotor. The rotational drive shaft is in one end connected to the rotor and is further connected to a propulsion unit, such as an electrical motor. Thus, the drive shaft transmit torque and rotational movement from the propulsion unit to the rotor. A transmission, comprising gear wheels may be arranged between the propulsion unit and the drive shaft. The transmission may be accommodated in a transmission housing comprising a lubricant, such as oil, for lubricating the transmission.

The rotational drive shaft may be a hollow shaft for introducing liquid feed mixture to be separated to the inlet to the rotor. Thus, the fluid mixture may be introduced to the rotor and the rotational bowl through a central cavity of the rotational drive shaft. The central cavity may thus form a central bore, which extends in the longitudinal direction of the drive shaft. As an alternative, the rotational drive shaft may be a hollow shaft through which one of the separated phases is discharged, i.e. the central cavity or bore may be connected to an outlet of the rotor.

The protecting collar may be arranged on the rotatable drive shaft. The rotatable drive shaft may pass through the first and second opening of the cavity of the collar. The rotatable drive shaft may be configured to generate a rotatable movement of the protecting collar. The rotatable drive shaft may be configured to generate a rotatable movement about the centre axis of the protecting collar. A centre axis of the drive shaft may coincide with the centre axis of the protecting collar. The protecting collar is configured to prevent leakage of lubricant from the centrifugal separator to the surroundings. Thus, the protecting collar may be a centrifugal separator protecting collar. The protecting collar protects the centrifugal separator from lubricant leakage.

According to an aspect, the cavity of the protecting collar comprises a throttle ring, which has an outer diameter smaller than the inner diameter of the first inner peripheral surface portion, which throttle ring is configured to stand still during the rotational movement of the protecting collar. Since the outer diameter of the throttle ring is smaller than the inner diameter of the first inner peripheral surface portion, the collar is free to rotate in relation to the throttle ring. Due to the difference in diameter between the outer diameter of the throttle ring and the inner diameter of the first inner peripheral surface portion, a cylinder-shaped gap is formed between the throttle ring and the collar. The lubricant is prevented to pass through the cylinder-shaped gap by the lubricant barrier generating element of the collar. An end surface of the throttle ring may be configured to abut the inner abutment surface of the inner wall of the protecting collar. However, there may be a small gap between the abutment surface and the end surface of the throttle ring to allow rotational movement of the protecting collar during operation. The throttle ring may be allowed to move on an axial direction in relation to the collar. The throttle ring may comprise a central through hole. The rotatable drive shaft may be arranged to pass through the central through hole of the throttle ring. The central through hole of the throttle ring has a larger diameter than an outer diameter of the rotatable drive shaft.

According to an aspect, the separator further comprises a bearing housing, which at least partly surrounds the rotatable drive shaft and the protecting collar, and wherein a bearing is arranged to axially fixate the protecting collar on the rotatable drive shaft. The bearing may be arranged between the bearing housing and the rotational drive shaft. The bearing housing may be fixed to the frame or the transmission housing of the separator. Thus, the bearing housing is configured to stand still and support the rotational drive shaft and the rotor.

According to an aspect, the bearing is a bottom bearing of the centrifugal separator for supporting the rotational drive shaft. A number of bearings may be arranged for supporting the rotational drive shaft. However, the bearing arranged in the bearing house is a bottom bearing of the centrifugal separator. The bottom bearing in the separator is the lowermost bearing arranged to support the drive shaft.

According to an aspect, the bearing housing is provided with a lubricant passage, which is configured to pass through the bearing and an outer peripheral surface of an outer wall of the protecting collar, and further to at least one drain outlet of the bearing housing. The bearing arranged in the bearing housing needs lubrication in order to decrease friction and ware of the bearing. In addition, the lubricant may have a cooling effect on the bearing. The lubricant may be flushed into the bearing by the movement of the transmission, which is partly drained in the lubricant. After the lubricant has passed the bearing, the lubricant is flowing in the lubricant passage and leaving the bearing housing through one or more outlets of the bearing housing. From the outlets of the bearing housing, the lubricant flows back to the transmission housing. Since the drive shaft pass through the bearing housing and further out of the frame or transmission housing of the separator, the gap between rotatable driving shaft and the bearing housing must be sealed in order to prevent any leakage of lubricant out of the housing. The protecting collar is configured to prevent leakage of lubricant from the transmission housing to the surroundings.

According to an aspect, the bearing housing comprises a tapered portion, which is configured to protrude into the cavity of the protecting collar. The inner wall of the cavity of the collar may comprise a second inner peripheral surface portion adjacent to the first inner peripheral surface portion, which second inner peripheral surface portion has a tapered shape. The tapered shape of the second inner peripheral surface portion may be adapted to the tapered portion of the bearing housing. The gap or column between the second inner peripheral surface portion and the tapered portion of the bearing housing may have a circumferential conical shape. The circumferential conical shaped gap or column may have a shape similar to a truncated cone. The circumferential conical shaped gap or column may have connection to the lubricant passage in the bearing housing. However, the lubricant barrier of the collar is configured to prevent any lubricant to leak through the barrier and out of the separator.

The present invention will now be further illustrated with reference to the appended figures.

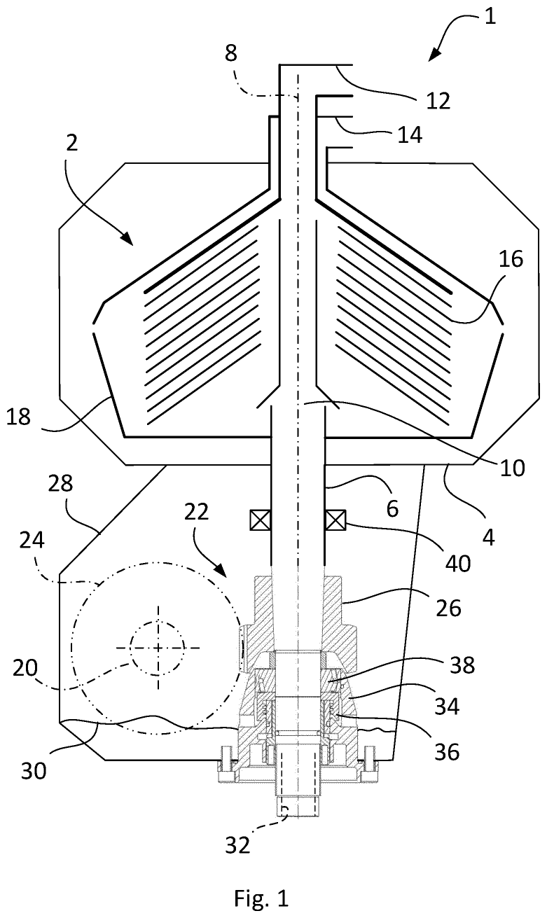

FIG. 1 illustrates a schematic side view of a centrifugal separator 1 according to an example. The centrifugal separator 1 is comprising a rotor 2, which is rotatably supported by a frame 4 around a rotational drive shaft 6, and more specifically around centre axis 8 of the drive shaft 6. The rotor 2 comprises an inlet 10 for supplying a liquid mixture to the rotor 2 via the rotational drive shaft 6. The separator 1 further comprises a first outlet 12 for a separated lighter first component of the fluid mixture and a second outlet 14 for a separated denser second component of the fluid mixture. Separation discs 16 are stacked in a rotating bowl 18 at a mutual distance to form interspaces between themselves. The rotational drive shaft 6 is in one end connected to the rotor 2 and at the other portion connected to a propulsion unit 20. A transmission 22, comprising gear wheels 24, 26 is arranged between the propulsion unit 20 and the drive shaft 6. The transmission 22 is accommodated in a transmission housing 28 comprising a lubricant 30. The inlet 10 to the rotor 2 is connected to a central bore 32, which extends in the longitudinal direction of the drive shaft 6. A bearing housing 34 is configured to surround the rotatable drive shaft 6 and a protecting collar 36 according to the present disclosure. A bottom bearing 38 is arranged to axially fixate the protecting collar 36 on the rotatable drive shaft 6. The bearing housing 34 is fixed to the transmission 22 housing of the separator 1. A further bearing 40 may be arranged to support the drive shaft 6 and the rotor 2.

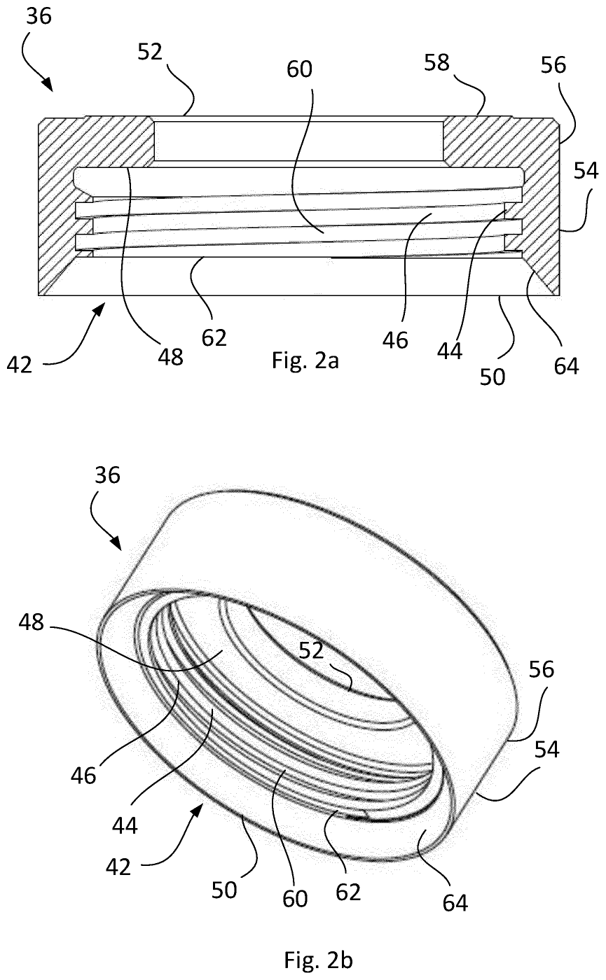

FIG. 2a illustrates a section view of a protecting collar 36 according to an example and FIG. 2b illustrates a view in perspective of a protecting collar 36 according to an example. According to FIGS. 2a and 2b, the protecting collar 36 comprises a cavity 42 provided with an inner wall 44 comprising a first inner peripheral surface portion 46 and an inner abutment surface 48. The protecting collar 36 further comprises a first and a second opening 50, 52 of the cavity 42, which first opening 50 has a larger diameter than the second opening 52. An outer wall 54 of the protecting collar 36 comprises an outer peripheral surface 56 and an outer abutment surface 58. The protecting collar 36 further comprises a lubricant barrier generating element 60 arranged in the first inner peripheral surface portion 46. The lubricant barrier generating element 60 is configured to prevent the lubricant 30 to pass the lubricant barrier generating element 60 during a rotational movement of the protecting collar 36. The lubricant barrier generating element 60 is a helical groove 60 formed in the first inner peripheral surface portion 46. During a rotational movement of the protecting collar 36, the helical groove 60 prevents the lubricant 30 to pass the helical groove 60. A groove opening 62 of the helical groove 60 is configured to trail in the lubricant 30 during the rotational movement of the collar 36, so that the lubricant 30 is prevented to enter the helical groove 60. The inner wall 44 of the cavity 42 comprises a second inner peripheral surface portion 64 adjacent to the first inner peripheral surface portion 46. The second inner peripheral surface portion 64 has a tapered shape. The shape of the outer peripheral surface 56 of the outer wall 54 is configured to guide a flow of lubricant 30 past the collar 36.

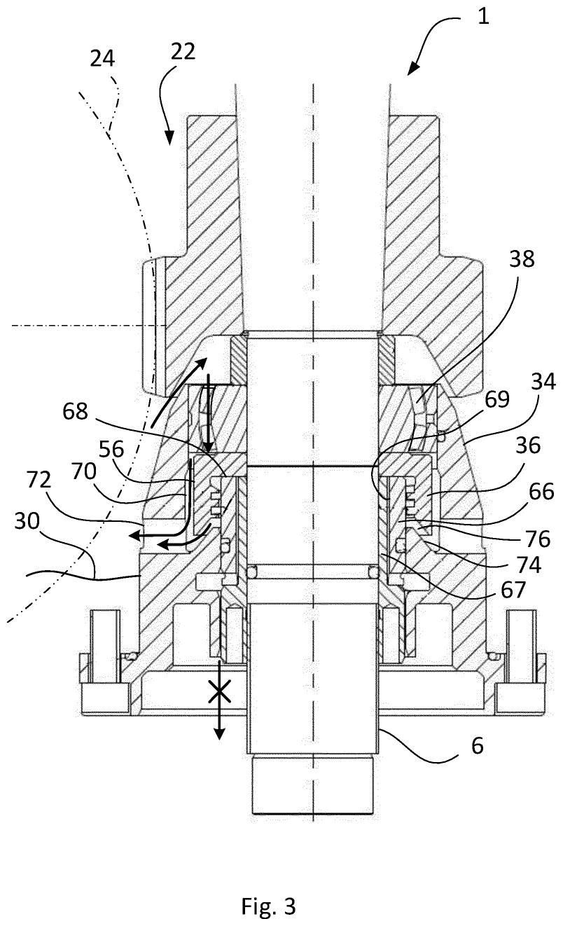

FIG. 3 illustrates a section view of a protecting collar 36 arranged in a bearing housing 34 of a centrifugal separator 1 according to an example. The bearing housing 34 in FIG. 3 corresponds to the bearing housing 34 disclosed in FIG. 1. The protecting collar 36 disclosed in FIG. 3 is arranged on the rotatable drive shaft 6. The rotatable drive shaft 6 may pass through the first and second opening 50, 52 (FIG. 2a) of the cavity 42 (FIG. 2a) of the collar 36. The rotatable drive shaft 6 is configured to generate a rotatable movement of the protecting collar 36. The cavity 42 of the protecting collar 36 is configured to receive a throttle ring 66, which has an outer diameter smaller than the inner diameter of the first inner peripheral surface portion 46 (FIG. 2a), which throttle ring 66 is configured to stand still during the rotational movement of the protecting collar 36. An end surface 68 of the throttle ring 66 is configured to abut the inner abutment surface 48 (FIG. 2a) of the inner wall 44 (FIG. 2a) of the protecting collar 36. The rotatable drive shaft 6 is arranged to pass through the central through hole 69 of the throttle ring 66. A sleeve 67 is arranged on the drive shaft 6. The sleeve 67 is radially arranged between the throttle ring 66 and the drive shaft 6. The bottom bearing 38 is arranged to axially fixate the protecting collar 36 on the rotatable drive shaft 6. The bottom bearing 38 is arranged between the bearing housing 34 and the rotational drive shaft 6.

The bearing housing 34 is provided with a lubricant passage 70, which is configured to pass through the bottom bearing 38 and an outer peripheral surface 56 of an outer wall 54 (FIG. 2a) of the protecting collar 36, and further to at least one drain outlet 72 of the bearing housing 34. The lubricant 30 is flushed into the bottom bearing 38 by the movement of the transmission 22. One of the gear wheels 24 of the transmission 22 is partly drained in the lubricant 30. The rotation of the gearwheel 24 generates a flow of lubricant 30 into the lubricant passage 70. After the lubricant 30 has passed the bottom bearing 38, the lubricant 30 is flowing in the lubricant passage 70 and leaving the bearing housing 34 through outlets of the bearing housing 34. From the outlets, the lubricant 30 flows back to the transmission 22 housing. Since the drive shaft 6 pass through the bearing housing 34 and further out of the frame 4 (FIG. 1) or transmission housing 28 (FIG. 1) of the separator 1, any leakage of lubricant 30 must be prevented between rotatable drive shaft 6 and the bearing housing 34. The protecting collar 36 is configured to prevent leakage of lubricant 30 from the transmission housing 28 to the surroundings, which is depicted in FIG. 3 with an arrow, which is crossed over.

The bearing housing 34 comprises a tapered portion 74, which is configured to protrude into the cavity 42 of the protecting collar 36. The tapered shape of the second inner peripheral surface portion 64 (FIG. 2a) is adapted to the tapered portion 74 of the bearing housing 34. The gap 76 or column between the second inner peripheral surface portion 64 and the tapered portion 74 of the bearing housing 34 has a circumferential conical shape. The circumferential conical shaped gap 76 or column has a shape similar to a truncated cone. The circumferential conical shaped gap 76 or column has connection to the lubricant passage 70 in the bearing housing 34.

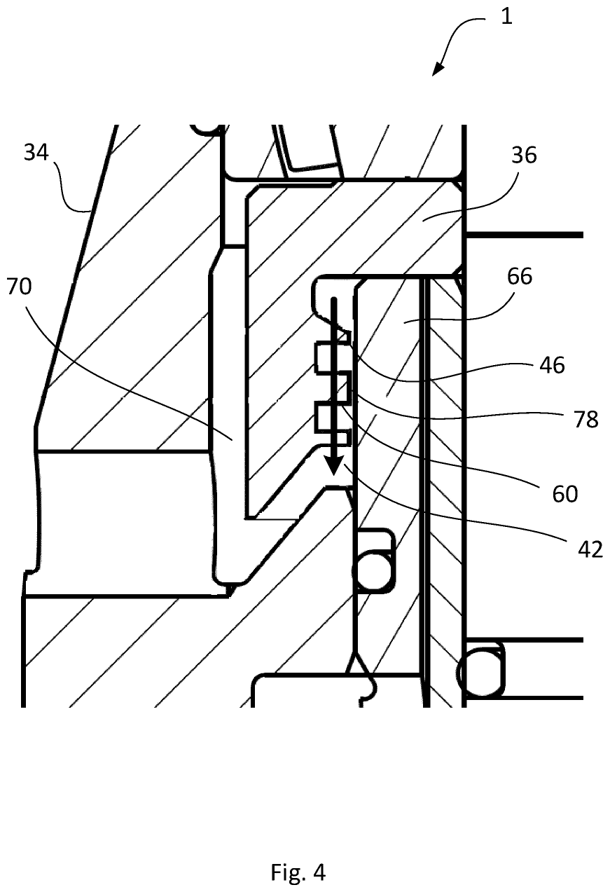

FIG. 4 illustrates a detail section view of a protecting collar 36 arranged in a bearing housing 34 of a centrifugal separator 1 according to an example. Since the outer diameter of the throttle ring 66 is smaller than the inner diameter of the first inner peripheral surface portion 46, the collar 36 is free to rotate in relation to the throttle ring 66. Due to the difference in diameter between the outer diameter of the throttle ring 66 is smaller than the inner diameter of the first inner peripheral surface portion 46 a cylinder-shaped gap 78 is formed between the throttle ring 66 and the collar 36. The lubricant 30 (FIG. 3) is prevented to pass through the cylinder-shaped gap 78 by the helical groove 60 in the collar 36. The lubricant 30 will be forced by the rotational movement of the helical groove 60 to enter the helical groove 60. During a rotational movement of the protecting collar 36, the helical groove 60 may generate a lubricant 30 flow out of the cavity 42, which is depicted by a vertical arrow in FIG. 4. Any lubricant 30, which may enter the helical groove 60, may be flushed out of the helical groove 60 by the generated lubricant 30 flow of the helical groove 60. The circumferential conical shaped gap 78 or column has connection to the lubricant passage 70 in the bearing housing 34. However, the helical groove 60 of the collar 36 is configured to prevent any lubricant 30 to leak out of the separator 1 by the lubricant 30 barrier generated by the helical groove 60 of the protecting collar 36.

The foregoing description of the embodiments has been furnished for illustrative and descriptive purposes. It is not intended to be exhaustive, or to limit the embodiments to the variations described. Many modifications and variations will obviously be apparent to one skilled in the art. The embodiments have been chosen and described in order to best explicate principles and practical applications, and to thereby enable one skilled in the arts to understand the invention in terms of its various embodiments and with the various modifications that are applicable to its intended use. The components and features specified above may, within the frame 4work of the disclosure, be combined between different embodiments specified.

1. A protecting collar for a centrifugal separator, the protecting collar being arranged to rotate with a rotatable part of the centrifugal separator and comprising:
a cavity provided with an inner wall comprising a first inner peripheral surface portion and an inner abutment surface;
a first and a second opening of the cavity, the first opening having a larger diameter than the second opening;
an outer wall comprising an outer peripheral surface and an outer abutment surface; and
a lubricant barrier generating element arranged in the first inner peripheral surface portion, the lubricant barrier generating element being configured to prevent the lubricant to pass the lubricant barrier generating element during a rotational movement of the protecting collar,
wherein the lubricant barrier generating element is a helical groove formed in the first inner peripheral surface portion.

2. The collar according to claim 1, wherein a groove opening of the helical groove is configured to trail in the lubricant during the rotational movement of the collar, so that the lubricant is prevented to enter the helical groove.

3. The collar according to claim 1, wherein the inner wall of the cavity comprises a second inner peripheral surface portion adjacent to the first inner peripheral surface portion, the second inner peripheral surface portion having a tapered shape.

4. The collar according to claim 1, wherein a shape of the outer peripheral surface of the outer wall is configured to guide a flow of lubricant past the collar.

5. The collar according to claim 1, wherein the cavity is configured to receive a throttle ring, the throttling ring having an outer diameter smaller than an inner diameter of the first inner peripheral surface portion and being configured to stand still during the rotational movement of the protecting collar.

6. The collar according to claim 1, wherein the cavity is configured to receive a rotatable drive shaft passing through the first and second opening.

7. A centrifugal separator for separating a fluid mixture into components, said centrifugal separator comprising:
a rotor rotatably supported by a frame around a rotatable drive shaft;
an inlet to the rotor;
a first outlet for a separated lighter first component of the fluid mixture;
a second outlet for a separated denser second component of the fluid mixture; and
the protecting collar according to claim 1 arranged on the rotatable drive shaft.

8. The centrifugal separator according to claim 7, wherein the cavity of the protecting collar comprises a throttle ring having an outer diameter smaller than an inner diameter of the first inner peripheral surface portion, the throttle ring being configured to stand still during the rotational movement of the protecting collar.

9. The centrifugal separator according to claim 7, further comprising a bearing housing at least partly surrounding the rotatable drive shaft and the protecting collar, wherein a bearing is arranged to axially fixate the protecting collar on the rotatable drive shaft.

10. The centrifugal separator according to claim 9, wherein the bearing is a bottom bearing of the centrifugal separator for supporting the rotatable drive shaft.

11. The centrifugal separator according to claim 9, wherein the bearing housing is provided with a lubricant passage configured to pass through the bearing, an outer peripheral surface of an outer wall of the protecting collar and at least one drain outlet of the bearing housing.

12. The centrifugal separator according to claim 9, wherein the bearing housing comprises a tapered portion configured to protrude into the cavity of the protecting collar.

13. The collar according to claim 2, wherein the inner wall of the cavity comprises a second inner peripheral surface portion adjacent to the first inner peripheral surface portion, the second inner peripheral surface portion having a tapered shape.

14. The collar according to claim 2, wherein a shape of the outer peripheral surface of the outer wall is configured to guide a flow of lubricant past the collar.

15. The collar according to claim 3, wherein a shape of the outer peripheral surface of the outer wall is configured to guide a flow of lubricant past the collar.

16. The collar according to claim 2, wherein the cavity is configured to receive a throttle ring, the throttling ring having an outer diameter smaller than an inner diameter of the first inner peripheral surface portion and being configured to stand still during the rotational movement of the protecting collar.

17. The collar according to claim 3, wherein the cavity is configured to receive a throttle ring, the throttling ring having an outer diameter smaller than an inner diameter of the first inner peripheral surface portion and being configured to stand still during the rotational movement of the protecting collar.

18. The collar according to claim 4, wherein the cavity is configured to receive a throttle ring, the throttling ring having an outer diameter smaller than an inner diameter of the first inner peripheral surface portion and being configured to stand still during the rotational movement of the protecting collar.

19. The collar according to claim 2, wherein the cavity is configured to receive a rotatable drive shaft passing through the first and the second opening.

20. The collar according to claim 3, wherein the cavity is configured to receive a rotatable drive shaft passing through the first and the second opening.
